(19) United States
(12) Patent Application Publication
(10) Pub. No.: US 2021/0197419 A1
(43) Pub. Date: Jul. 1, 2021

(54) MODIFIED WOOD PRODUCT

(71) Applicant: Lignia Wood Company Limited, Barry (GB)

(72) Inventors: Andrew John PITMAN, Long Crendon (GB); Hans Mann-Kern NG, Coleford (GB); Justin ELS, Cromer (GB)

(21) Appl. No.: 17/197,843

(22) Filed: Mar. 10, 2021

Related U.S. Application Data
(63) Continuation of application No. PCT/EP2019/074366, filed on Sep. 12, 2019.

(30) Foreign Application Priority Data
Sep. 12, 2018 (GB) 1814839.5

(51) Int. Cl. B27K 5/00; B27K 3/02

(52) U.S. Cl. CPC B27K 5/001; B27K 3/0278

(57) ABSTRACT

A method of producing a modified wood product is disclosed. The method comprises heating a resin impregnated wood product in a reactor, the resin impregnated wood product comprising source wood impregnated with a resin composition comprising resin, the heating being so as to substantially cure the resin, thereby to produce the modified wood product. The method comprises, during the heating of the resin impregnated wood product in the reactor, introducing water into the reactor. A reactor and a modified wood product are also disclosed.

### CROSS-REFERENCE TO RELATED APPLICATIONS

This application is a continuation of International Application No. PCT/EP2019/074366, filed Sep. 12, 2019 which claims priority to UK Application No. GB 1814839.5, filed Sep. 12, 2018, under 35 U.S.C. § 119(a). Each of the above-referenced patent applications is incorporated by reference in its entirety.

### BACKGROUND

### Field of the Invention

The present invention relates to a method of producing a modified wood product, a reactor for producing a modified wood product, and a modified wood product.

### Description of the Related Technology

Wood, such as sapwood of plantation pines such as radiata pine (Pinus radiata), may be produced sustainably and at relatively low cost. However, the properties of raw wood may not be particularly suited or optimised for some applications, for example for use as a building material. For example, the wear resistance, fungi resistance, fire resistance, and/or dimensional stability of raw wood can place limitations on the effectiveness of it use in varying practical applications such as in flooring, decking, cladding, joinery, including exterior joinery such as for window and door frames.

Wood modification processes to alter properties of raw wood are known. It is known to modify raw wood in a process where a step of resin treatment is followed by a thermal modification step, for the aim of improving biological stability of the wood.

However, it is desirable to provide an improved modified wood product having properties that mitigate at least some of the limitations of raw wood and/or of known wood products, as well as to provide an improved method of producing the modified wood product.

### SUMMARY

According to a first aspect of the present invention, there is provided a method of producing a modified wood product, the method comprising:

heating a resin impregnated wood product in a reactor, the resin impregnated wood product comprising source wood impregnated with a resin composition comprising resin, the heating being so as to substantially cure the resin, thereby to produce the modified wood product;

wherein the method comprises, during the heating of the resin impregnated wood product in the reactor, introducing water into the reactor.

Optionally, the introducing the water into the reactor comprises introducing the water into the reactor when a core portion of the resin impregnated wood product reaches a temperature in the range 120° C. to 130° C.

Optionally, the introducing the water into the reactor comprises introducing the water into the reactor in the form of a spray or aerosol.

Optionally, the introducing the water into the reactor comprises introducing the water into the reactor via one or more nozzles located at or towards a top portion of the reactor.

Optionally, the introducing the water into the reactor comprises introducing a volume of water in the range 20 to 30 millilitres per square meter of surface area of resin impregnated wood product in the reactor.

Optionally, the introducing the water into the reactor comprises introducing water into the reactor a rate in the range of 700 to 900 millilitres per minute, or preferably at a rate of about 800 millilitres per minute.

Optionally, the resin composition is an aqueous solution of phenol formaldehyde resin.

Optionally, the aqueous solution of phenol formaldehyde resin has a solids content in the range of 20% to 40%, or preferably a solids content of around 30%.

Optionally, the heating the resin impregnated wood product in the reactor so as to substantially cure the resin comprises heating the resin impregnated wood product so that a core portion of the resin impregnated wood product has a temperature in the range 130° C. to 170° C., or preferably a temperature of about 150° C.

Optionally, the heating the resin impregnated wood product in the reactor so as to substantially cure the resin comprises:

sealing the resin impregnated wood product in the reactor;

increasing the pressure in the reactor to a pressure in the range of between about 700 kPa to about 1300 kPa.

Optionally, the method comprises, during the heating the resin impregnated wood product in the reactor, introducing inert gas into the reactor.

Optionally, the method comprises, after the heating the resin impregnated wood product in the reactor so as to substantially cure the resin:

venting the reactor;

increasing the pressure in the reactor; and

venting the reactor again.

Optionally, the method comprises:

impregnating the source wood with the resin composition, thereby to produce the resin impregnated wood product.

Optionally, the source wood has a moisture content in the range of about 10% to about 14%.

Optionally, the method comprises:

prior to the impregnating the source wood with the resin composition, drying the source wood so that the source wood has a moisture content of about 10% to about 14%.

Optionally, the impregnating the source wood with the resin composition comprises:

sealing the source wood in a chamber;

drawing a first reduced pressure in the chamber;

introducing the resin composition into the chamber so as to fully immerse the source wood;

applying a first increased pressure to the resin composition whilst fully immersed so as to impregnate the source wood with the resin composition; and

draining the resin composition from the chamber; and

drawing a second reduced pressure in the chamber so as to remove excess resin composition from the resin impregnated source wood, thereby to produce the resin impregnated wood product.

Optionally, the applying the first increased pressure to the resin composition comprises applying a pressure in the range 1000 kPa to 1400 kPa, or preferably a pressure of around 1200 kPa, to the resin composition.

Optionally, the method comprises:

before the heating the resin impregnated wood product, reducing the moisture content of the resin impregnated wood product to a moisture content in the range of about 4% to about 10%.

Optionally, the reducing the moisture content of the resin impregnated wood product comprises heating the resin impregnated wood product in a kiln at a temperature in the range of about 50° C. to about 60° C.

According to a second aspect of the present invention, there is provided a reactor for producing a modified wood product, the reactor being arranged to heat a resin impregnated wood product received therein in use so as to substantially cure the resin, thereby to produce the modified wood product in use, the reactor comprising:

water introduction means for introducing water into the reactor during said heating of the resin impregnated wood product in use.

Optionally, the water introduction means is arranged to introduce water into the reactor in the form of a spray or aerosol.

Optionally, the water introduction means comprises one or more nozzles located at or towards a top portion of the reactor.

Optionally, the reactor is arranged to perform the method according to any one of claim 2 to claim 12.

According to a third aspect of the present invention, there is provided a modified wood product, the modified wood product comprising a timber of source wood impregnated with cured phenol formaldehyde resin, wherein the modified wood product has a density in the range of substantially 550 kg/m³ to substantially 950 kg/m³.

Optionally, the phenol formaldehyde resin is phenol urea formaldehyde resin.

Further features and advantages of the invention will become apparent from the following description of examples of the invention, given by way of example only, which is made with reference to the accompanying drawings.

### BRIEF DESCRIPTION OF THE DRAWINGS

FIG. 1 illustrates schematically a method of producing a modified wood product according to an example; and

FIG. 2 illustrates schematically a system comprising a reactor for producing a modified wood product, according to an example.

### DETAILED DESCRIPTION

In broad overview, a method of producing a modified wood product according to the examples described herein comprises heating a resin impregnated wood product in a reactor so as to substantially cure the resin; and, during the heating of the resin impregnated wood product in the reactor, introducing water into the reactor. The inventors have appreciated that introducing water into the rector during curing by heating of the resin impregnated wood product provides a number of advantages. As explained in more detail below, these advantages include reduction of cracking of the surface of the resin impregnated wood product during curing; improved reliability and consistency of the curing of the resin impregnated wood product; allowing improved removal of curing by-products from the resin impregnated wood product; and/or reduction of charring of the surface of the resin impregnated wood product during curing.

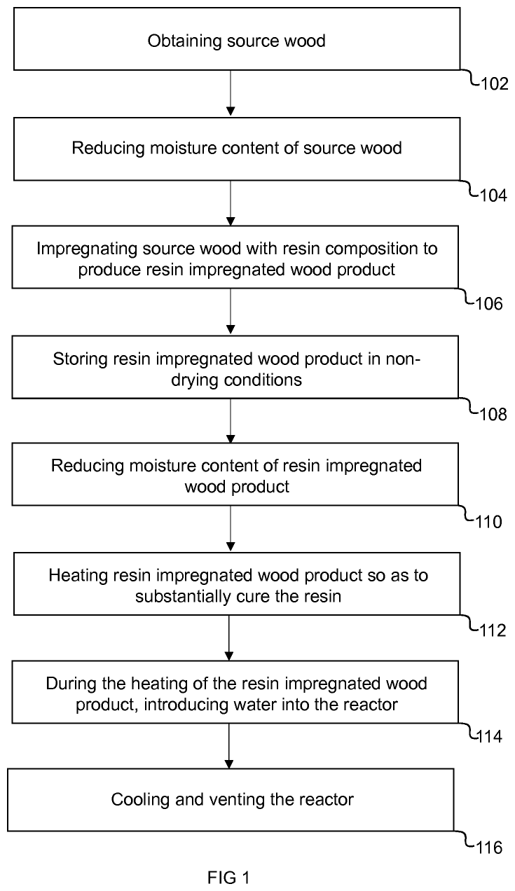

A method of producing a modified wood product according to an illustrative example will now be described with reference to FIG. 1.

The example method comprises, in step 102, obtaining source wood.

The source wood may be in the form of one or more timbers each having a length in the range 1200 to 6000 millimetres (hereinafter mm), a width in the range 50 to 300 mm (for example with a tolerance of −2 mm to +4 mm) and a thickness in the range 25 mm to 100 mm (for example with a tolerance in the range −1 mm to +3 mm). The timbers may have a sawn finish. As described in more detail below, in some examples, the source wood may be the form of a plurality of timbers that may be processed together in a batch. It will be appreciated that in other examples, other forms of source wood may be used.

The source wood may be selected to be of suitable quality for the modification process. For example, timbers may be inspected for naturally occurring wood features which may be considered as defects in the modified wood product. For example, these defects may comprise knots, wane, wood resin pockets and streaks, decay pockets, splits, warp, fissures, excessive stain and mechanical damage. The selection of timbers as the source wood for use in the wood modification process may comprise selecting timbers that include less than a certain number or size of defect.

The source wood is specifically selected to be permeable to liquids. For example, the source wood may have Class 1 permeability to liquids (also known as Class 1 treatability), permeability/treatability classes being defined by European Standard EN350:2016 Durability of wood and wood-based products—Testing and classification of the durability to biological agents of wood and wood-based materials. The source wood being permeable to liquids, for example having a Class 1 permeability, may allow for the source wood to be readily and fully penetrated by and impregnated with a resin composition (described in more detail below). This may allow for improved efficiency of the wood modification process, and/or for more reliable and consistent wood modification.

The source wood may be, for example, sapwood, for example the sapwood of plantation pines, for example radiata pine (Pinus radiata De Don) or Pinus strobus. In other examples, the source wood may be the sapwood or the heartwood of selected hardwoods known to be permeable, for example European beech (Fagus sylvatica) and tulipwood sapwood (Liriodendron tulipifera, Alnus glutinosa, A. incana, Carpinus betulus; Endospermum medullosum)

The example method comprises, in step 104, reducing the moisture content of the source wood. For example, the method may comprise drying the source wood so that the source wood has a moisture content of about 10% to about 14% (percent by weight on an oven-dry weight basis). For example, the source wood may be kiln-dried to a moisture content of about 10%-14%. It will be appreciated that in some examples the method need not comprise reducing the moisture content of the source wood. For example, the source wood obtained may already have a suitable moisture content, for example a moisture content of not more than 14%, for example in the range 10%-14%. In either case, the source wood having a suitable moisture content may be stored undercover or in an otherwise moisture-controlled environment. The source wood having a moisture content of not more than 14%, for example in the range 10%-14%, may provide for adequate void spaces in the source wood for the uptake of resin, as described in more detail below.

The moisture content of the source wood may be determined using a moisture meter calibrated for the timber species of the source wood. The moisture meter may be fitted with hammer probes to allow the moisture content at a core portion of the source wood timber to be determined. In some examples, the source wood may be in the form of a plurality of source wood timbers that form a batch for the wood modification process. In these examples, or otherwise, the average moisture content of the batch may be determined. For example, the moisture content may be measured of timbers towards the top, middle, and bottom of the batch, and these moisture contents may be averaged to determine the average moisture content of the batch. The determined average moisture content of the batch may then be used as the moisture content of the source wood.

In some examples, for example for quality control purposes, the theoretical oven dry weight and/or the oven-dry density of the source wood may be calculated. For example, the weight or mass of the source wood may be determined using a calibrated balance. The oven-dry mass M_{OD} of the source wood may then be calculated using the formula: M_{OD}=M_{S}/(1+MMC÷100)) (1) where M_{S} is the measured mass of the conditioned source wood, and % MC is the determined percentage moisture content of the source wood. The oven dry mass may allow for the resin uptake of the source wood to be calculated later in the wood modification process (described in more detail below). The volume of an individual timber of source wood may be determined by multiplying its length by its cross section. The total volume of a batch of similar timbers may be calculated by multiplying the volume of an individual timber by the number of timbers in the batch (provided of course that the timbers are of the same or similar size). The oven dry-density of the source wood may then be determined by dividing the determined oven dry mass of the source wood by the determined volume of the source wood. The oven-dry density may allow the density increase due to wood modification process to be determined later in the process (as described in more detail below).

As mentioned above, the source wood may be in the form of a plurality of timbers forming a batch for the wood modification process. In some examples, the timbers or boards of source wood may be ‘close stacked’, i.e. laid on top of one another and next to one another so that their faces touch. In other examples, the timbers or boards of source wood may be ‘on stick’, i.e. separated with hardwood stickers. For example, the hardwood stickers may be around 22 mm by 30 mm in cross section. The hardwood stickers may be placed at 600 mm intervals along the length of the timbers and extend substantially perpendicular to the length axis of the timbers. The timbers of the batch may be strapped fast in one or more locations to help ensure that the timbers remain aligned during the processing.

The method comprises, in step 106, impregnating the source wood with a resin composition comprising resin to produce a resin impregnated wood product.

The resin may be phenol formaldehyde. For example, the resin may be Phenol Urea Formaldehyde (PUF). For example, the resin may be Phenol Urea Formaldehyde (PUF) P3026 obtainable from Hexion. For example, the PUF may be obtained at a solids content of or exceeding 40% (weight by volume, wt/vol). The method may comprise confirming the viability of the resin prior to its use by measuring its water tolerance and pH, to confirm that the values correspond to those provided by the resin supplier or manufacturer, for example immediately after manufacture.

The resin composition may be diluted resin. For example, the resin composition may be an aqueous solution of the resin (e.g. an aqueous solution of phenol formaldehyde, e.g. PUF P3026). The aqueous solution of resin may be made by diluting the resin with water to a solids content in the range 20%-40% (wt/vol) for example a solids content of 30% (wt/vol). The resin solids content in the resin composition may be measured using refractometry and gravimetric methods. The method may comprise confirming that the solids content of the resin composition is 30% immediately prior to use in impregnation.

The impregnation may be conducted using a suitable apparatus, for example an apparatus comprising a sealable chamber in which the source wood may be introduced, and which may be flooded with resin composition so as to immerse the source wood in the resin composition, and/or in which reduced pressure (i.e. partial vacuum) and an increased pressure may be applied. For example, the impregnation may be conducted in an autoclave.

The impregnation may comprise an impregnation sub-process (not illustrated) to produce the resin impregnated wood product. For example, the impregnation sub-process may comprise a vacuum/pressure/vacuum cycle in the autoclave.

For example, the impregnation sub-process may comprise sealing the source wood in a chamber (for example a chamber defined by the autoclave) and drawing a first reduced pressure in the chamber. For example, the first reduced pressure in the chamber may be 80 kPa. The first reduced pressure may be drawn for a time period in the range 15-60 minutes, for example for 38 minutes. Drawing the first reduced pressure may allow for air to be drawn from voids in the source wood such that when the resin is applied under pressure the resin may penetrate the source wood more efficiently.

The impregnation sub-process may then comprise introducing the resin composition into the chamber so as to immerse the source wood in the resin composition. For example, the chamber may be completely flooded with resin composition. The volume of resin composition to prepare and/or introduce into the chamber for impregnation may be calculated in advance by determining the void space in the chamber of the autoclave after loading with the source wood and adding this to the void volume of the source wood (i.e. the space available in the source wood for uptake of resin composition). The void volume VV of the source wood (e.g. the batch of source wood) may be determined for example using the equation VV %=((D_{OD}/D_{ew})−1)*100 (2), where VV % is the void volume of the source wood as a percentage of the total volume of the source wood, D_{OD} is the oven dry density of the source wood, and D_{ew} is the density of the wood cell wall of the source wood. The determined volume of resin composition may then be added to the sealed chamber.

The impregnation sub-process may then comprise applying an increased pressure to the resin composition so as to impregnate the source wood with the resin composition. For example, the pressure may be in the range 1000 kPa to 1400 kPa, for example at or around 1200 kPa. The increased pressure may be applied, for example, for a period of 2-4 hours to allow. for the resin composition to fully impregnate the source wood, for example including in a core portion of the source wood. This pressure may allow for good impregnation without collapsing the cell structure of the source wood.

The impregnation sub-process may then comprise draining the resin composition from the chamber, i.e. draining the resin composition that has not been impregnated into nor is otherwise attached to the source wood.

The impregnation sub-process may then comprise drawing a second reduced pressure in the chamber so as to remove excess resin composition from the resin impregnated source wood, thereby to produce the resin impregnated wood product. The second reduced pressure in the chamber may be 80 kPa. The second reduced pressure may be applied for example for 30 to 60 minutes. Drawing the second reduced pressure may remove excess resin composition from the surface of the resin impregnated source wood and from the lumens of the source wood cells. This may allow for a cost-effective use of the resin, as the removed excess resin may be recovered for re-use. Further, this may allow to reduce the energy expended in drying the resin impregnated wood (described in more detail below) as removing the excess resin reduced the overall moisture content of the resin impregnated wood.

The method may comprise, for example as part of a quality control procedure, comparing the volume of resin uptake of the source wood as a result of impregnation to the theoretical void volume of the source wood. The theoretical void volume of the source wood may be determined, for example, using equation (2) described above. It may be determined that the source wood has been fully and/or suitably treated/impregnated, e.g. that resin occupies all voids in the source wood, if the resin uptake volume is within 10% if the theoretical void volume. The uptake of resin composition of the source wood in the impregnation process may be determined as the difference between the total volume of resin introduced in the chamber at the start of the impregnation sub-process and the total volume of resin extracted from the chamber at the end of the impregnation sub-process. The resin composition uptake may also be determined by calculating the difference between the weight of the source wood at the start of the impregnation sub-process and the weight of the resin impregnated wood product at the end of the impregnation sub-process provided no final vacuum is drawn. The uptake may be calculated for a volume of wood in the autoclave.

The example method comprises, in step 108, storing the resin impregnated wood product in non-drying conditions. For example, the resin impregnated wood product may be removed from the chamber of the autoclave and transferred to a diffusion area where it is stored. For example, the resin impregnated wood product may comprise resin impregnated timbers in a ‘close stacked’ or ‘on stick’ arrangement, as described above. The resin impregnated wood product may be stored in non-drying conditions in either of these arrangements. The resin impregnated wood product may be stored in non-drying conditions at temperatures ranging from 5° C. to 20° C., for example for a period of between 0 and 8 days. It will be appreciated that the resin impregnated wood product need not necessarily be stored and may in other examples be transferred directly or near directly for curing (described in more detail below).

In some examples, for example for quality control purposes, one or more of the timbers of resin impregnated wood product may be weighed and their dimensions measured and recorded. The weighed/measured timbers may be labelled using heat and/or chemical resistant labels so that they can be readily identified later in the modification process.

The example method comprises, in step 110, reducing the moisture content of the resin impregnated wood product. For example, the moisture content of the resin impregnated wood product may be reduced to a moisture content in the range of 4% to 10%, for example in the range of 5% to 8% (percent by weight on an oven dry weight basis). For example, the moisture content may be reduced by heating the resin impregnated wood product in a drying-kiln with controlled venting, at a temperature in the range of 50° C. to 55° C. and/or reducing the relative humidity in the kiln to 10% (the relative humidity here being defined as the amount of water vapor in the air, expressed as a percentage of the maximum amount that the air could hold at the given temperature).

Reducing the moisture content of the resin impregnated wood product may comprise applying a moisture reducing sub-process. For example, the moisture reducing sub-process may comprise placing the resin impregnated timbers ‘on stick’ (for example as described above) to form a batch and transferring the batch to the kiln. Placing the timbers ‘on stick’ may help improve the airflow over and around the timbers, and hence may improve the moisture reduction process. The batch may be placed on a calibrated weigh bridge within the kiln to enable the monitoring of water loss by weight. The kiln may comprise sensors to enable continuous monitoring of the temperature and relative humidity within the kiln. The kiln may comprise an air flow means, for example a fan, arranged to maintain a target airspeed within the kiln of 2 to 3 ms⁻¹.

The moisture reducing sub-process may comprise applying a drying schedule where the temperature inside the kiln is caused to be in the range of 50° C. to 60° C., and the relative humidity inside the kiln is reduced from 80% to 10%. For example, the relative humidity may be actively controlled to keep it at a desired relative humidity level throughout drying schedule, for example through addition of moisture and venting of moisture from the kiln when greater or less humidity is required, respectively. For example, at an initial stage, the temperature in the kiln may be set at 50° C., and the relative humidity 80%. When the resin impregnated wood product reaches its equilibrium moisture content under these conditions (which may be defined for example as when there has been no reduction in the weight of the resin impregnated wood product over a four-hour period) then the relative humidity may be lowered and/or the temperature increased. For example, the temperature in the kiln may be increased to 55° C. and the relative humidity set to 70%. When the resin impregnated wood product reaches its equilibrium moisture content under these conditions, the temperature may remain at 55° C. and the relative humidity lowered to 60%. This process may be continued in suitable steps until the resin impregnated wood product reaches its equilibrium moisture content under the conditions of a kiln temperature of 55° C. and a relative humidity inside the kiln of 10%. The moisture content of the resin impregnated wood product may be determined as sufficiently reduced (i.e. the resin impregnated wood product may be determined as sufficiently dry) for further use in the wood modification process, when the resin impregnated wood product reaches its equilibrium moisture content under the conditions of a kiln temperature of 55° C. and a relative humidity inside the kiln of 10%. The above described drying schedule may have a duration of, for example 20 days for 25 mm-thick timbers of resin impregnated wood product, but this may vary by thickness and plane of cut (e.g. whether the source wood is flat sawn or quarter sawn from a log, which may influence drying rates).

The method may comprise, for example for quality control purposes, determining the moisture content of the resin impregnated wood product during and after drying in the kiln. For example, the moisture content may be calculated from the weight of the resin impregnated wood product (known from the calibrated weigh bridge within the kiln). The oven dry mass or weight of the source wood is known from equation (1). The weight of the of the resin impregnated wood is the oven dry mass or weight of the source wood, as well as the weight or mass due to moisture content and the weight or mass due to resin solids content. The resin solids content may be determined from the resin uptake (for example calculated as described above) and from the solids concentration of the resin composition. The weight or mass of the moisture content may be determined by subtracting from the measured weight of the resin impregnated wood, the oven dry weight of the source wood and the weight of the resin solids content. The moisture content may then be determined as the percentage proportion of the weight of the resin impregnated wood that is due to the moisture content. Oven-dry moisture content during or following drying may be determined by measuring a difference in weight of a piece or sample of a piece of the resin impregnated wood before and after oven drying at 105° C. to constant weight. The weight difference expressed as a percentage of oven dry weight may then be taken as the moisture content. Both the calculated and the oven-dry measured moisture content may be determined in order to reduce error in the moisture content determination. As mentioned above, the target moisture content of the resin impregnated wood product prior to curing may be 4%-8%.

The example method comprises, in step 112, heating the resin impregnated wood product in a reactor (e.g. the reactor 202 described below with reference to FIG. 3) so as to substantially cure the resin.

For example, the resin impregnated wood product may be transferred to within the reactor. As mentioned above, the resin impregnated wood product may comprise a plurality of resin impregnated timbers forming a batch for curing. The resin impregnated timbers may be placed into the reactor in an ‘on stick’ arrangement (for example as described above) in order to allow for circulation of hot air to all faces of the resin impregnated wood product.

One or more calibrated temperature measuring probes may be inserted into one or more holes drilled through to a core portion of the resin impregnated wood product. Inserting a temperature probe into a core portion of the resin impregnated wood product allows the monitoring of temperature inside the timber at a location further from its faces. The temperature measuring probes may be inserted so as to measure the temperature at the centre of the timber (i.e. in a region furthest from the end grains of the timber). In examples where there are a plurality of resin impregnated timbers forming a batch for curing, the temperature measuring probes may be inserted (for example as described above) into a proportion of the timbers, for example between 8 to 16 timbers of the batch. The temperature measuring probes may be inserted into timbers selected so as to provide temperature measurements from across the spatial distribution of timbers within the reactor. For example, temperature probes may be inserted into timbers located at the top, middle, and the bottom of the batch. An average core temperature of the batch may be determined by averaging the temperature measurements of the temperature probes

The heating the resin impregnated wood product in the reactor so as to cure the resin may comprise heating the resin impregnated wood product in the reactor so that the core portion of the resin impregnated wood product has a temperature in the range 130° C. to 170° C., for example a temperature of about 150° C. For example, the method may comprise sealing the resin impregnated wood product in the reactor. The method may then comprise increasing the pressure in the reactor to an initial pressure of 700 kPa. The method may then comprise increasing the pressure and the air temperature in the reactor from 60° C. to 160° C., for example over a period of 8 to 10 hours. For example, the temperature and pressure in the reactor may be increased gradually over the period until the average core temperature of the resin impregnated timbers reaches 150° C. For example, at this stage, the pressure may be between 1200 and 1300 kPa. When the average core temperature of the resin impregnated timbers reaches 150° C., the temperature is maintained for a hold period of 1 hour and at a pressure of between 1200 and 1300 kPa. Applying such pressures, for example that exceed the relative vapour pressure of water in the reactor during heating, may help prevent evaporation of water from the surfaces of resin impregnated wood product. This may help to reduce stress within the resin impregnated wood product, which, as also described in more detail below, may reduce or prevent cracking or other defect formation in the resin impregnated wood product. When the hold period has finished, the temperature may be gradually reduced, for example to 60° C.

The example method comprises, in step 114, during the heating of the resin impregnated wood product, introducing water into the reactor.

For example, the introducing the water into the reactor may comprise introducing the water into the reactor when a temperature of a core portion of the resin impregnated wood product reaches a temperature in the range 120° C.-130° C. For example, the water may be introduced into the reactor when the average core temperatures of the resin impregnated timbers (for example measured as described above) reaches 120° C. In other words, water may be introduced in the above-mentioned heating process in which the core temperature of the resin impregnated wood product eventually reaches 150° C., but the water is introduced at a stage in that heating process where the core temperature of the resin impregnated wood product has reached 120° C.

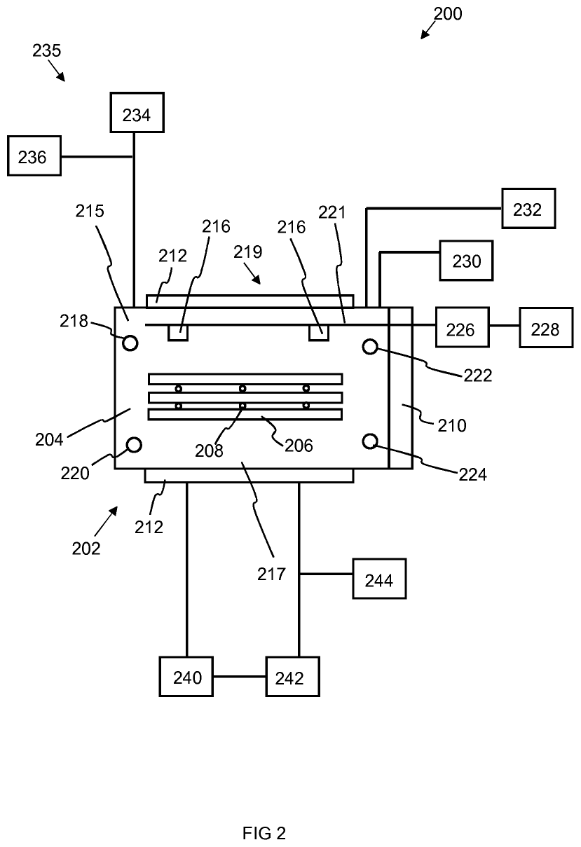

The water may be introduced into the reactor by injecting the water into the reactor. For example, a defined volume of water may be injected into the reactor. For example, the introducing the water into the reactor may comprise introducing the water into the reactor in the form of a spray or aerosol of water. For example, the water may be introduced via one or more nozzles located at or towards a top portion of the reactor (see e.g. nozzles 216 of FIG. 2, described in more detail below). For example, the nozzles may be installed on a spray bar at or towards a top portion of (and internal to) the reactor, and the spray bar may be connected to a controllable pump and/or valve arrangement to allow for the injection of a defined volume of water, for example at a defined rate of injection, into the reactor. The nozzles may be arranged to generate a spray or aerosol or mist of water. The water being in the form of a spray or aerosol or mist may allow for the water to deposit or add moisture evenly to all of the surfaces of the resin impregnated timbers being cured.

The introducing the water into the reactor may comprise introducing a defined volume of water in the range of 20 to 30 millilitres (hereinafter ml), for example around 25 ml, per square meter of surface area of the resin impregnated wood product in the reactor. For example, for 1 cubic meter of resin impregnated radiata pine in the reactor, a volume of water in the range 2200-3000 ml may be introduced into the chamber. This may depend on the surface area of the resin impregnated wood product, which may different for different processing of the source wood. For example, for one cubic meter of resin impregnated wood product having the form of timbers each having the dimensions 25 mm by 200 mm by 21000 mm, a volume of 2200 ml of water may be introduced into the reactor. As another example, for one cubic meter of resin impregnated wood product having the form of timbers each having the dimensions 25 mm by 50 mm by 21000 mm, a volume of 3000 ml of water may be introduced into the reactor.

The introducing the water into the reactor may comprise introducing water into the reactor at a rate in the range of 700 to 900 millilitres per minute, for example at a rate of around 800 millilitres per minute. For example, for a defined volume of 600 ml to be injected into the reactor, the water may be injected over a period of 45 seconds.

Introducing water into the reactor during heating, for example as described above, adds moisture to the surfaces of the resin impregnated wood product during curing. The inventors have appreciated that this provides a number of advantages as compared to not introducing water into the reactor during curing-by-heating as described above.

One advantage is that it is found that the introduction of water provides for a reduction (for example the substantial elimination) of cracking of the surface of the resin impregnated wood product (for example the formation of fissures in the surface of the resin impregnated wood) during curing, as compared to if water is not introduced. Cracking of or fissures forming in the surface of the modified wood product may reduce the utility of the product, as it may be less resistant to wear, and/or its appearance may be degraded. For examples, in applications of cladding and decking, surface cracks also known as checks may be seen as defects since they reduce aesthetic appeal and may lead to propagation of splits (i.e. cracks extending through the thickness of the modified wood product) on fixing of the modified wood product in place in use. The reduction or elimination of cracking may therefore improve the utility or usability of the modified wood product.

The reason for the reduction or elimination of cracking of the surface of the resin impregnated wood product by introduction of water into the reactor during curing is believed to be as follows. During the heating in the reactor, at least in part because the resin impregnated wood product is heated from the outside in, moisture is lost from the outer portions (including the surface) of the resin impregnated wood product before moisture is lost from the inner or core portions of the wood product. As moisture is lost from the outer portions, the outer portions shrink. However, the inner portion may still be relatively moist and hence relatively swollen as compared to the outer portions. This may produce a stress between the inner portions and the inner portions that cause the outer portions to crack and fissure. However, introduction of water into the reactor during the heating, for example injection of water in the form of a spray or aerosol when a core temperature of the resin impregnated wood product reaches 120° C., adds moisture to the outer portions of the wood product, thereby reducing the shrinkage of the outer portions relative to the inner portions of the wood product, thereby reducing the stress between the inner portion and the outer portion, thereby reducing (e.g. eliminating) cracking of the surface of the resin impregnated wood product during curing.

Another advantage is that it is found that the introduction of water provides for a reduction (for example the substantial elimination) of charring of the surface of the resin impregnated wood product during curing, as compared to if water is not introduced. Charring or blackening may degrade the appearance and/or versatility of application of the modified wood product, and hence reducing or eliminating charring may provide for an improved modified wood product. The reason for the reduction of charring provided by the introduction of water is believed to be as follows. As described above, during heating of the resin impregnated wood product, the wood is heated from the out-side in. The moisture content may therefore be lower (and the temperature higher) at the surface of the resin impregnated wood product as compared to the inner portions. At air temperatures inside the reactor necessary to heat the inner portions of the wood to sufficient curing temperatures therefore, there is a risk of uncontrolled drying of the surface portions of the resin impregnated wood product (and a risk of the surface portions reaching elevated temperatures as compared to the inner portions) and hence there may be a tendency of the surface portions to char. However, adding water to the reactor may, as described above, add moisture to the surface of the wood, which may prevent uncontrolled drying of the surface of the wood (and prevent surface portions reaching elevated temperatures as compared to the inner portions), and hence reduce or eliminate surface charring.

Another advantage is that it is found that the introduction of water provides for a more uniform temperature distribution over a plurality of spatially distributed resin impregnated timbers in the reactor during curing. This may provide for more consistent curing, and hence the modified wood product to be produced more consistently within a batch. This is believed to be because the water, for example in the form of a spray or aerosol, may obtain heat from the air (whose temperature distribution may not be uniformly distributed in the reactor), and apply that heat relatively evenly to the timbers as the aerosol flow through the reactor. For example, the temperature of the air inside the reactor may be higher towards the top of the reactor than towards the bottom of the reactor (as higher temperature air is less dense and so may rises above the lower temperature air which is less dense). Therefore, when water is injected from a nozzle at or towards the top portion of the reactor, the water may redistribute the heat inside the reactor as the water (for example in the form of a spay or an aerosol) flows from the nozzle towards the lower portion of the reactor.

Another advantage is that, in cases where phenol urea formaldehyde resin, or where another resin is used in which urea is a by-product of curing, it is found that the introduction of water into the chamber during heating allows for the urea by-product to be more readily and effectively removed as compared to if water is not introduced during curing. For example, when the phenol urea formaldehyde resin cures urea is produced. The urea may react with the introduced water to form gaseous ammonia. The ammonia which is volatile can then be readily purged from the reactor. Urea has an unpleasant smell, and hence may limit the usability of the modified wood product if present therein. Further, Urea may be difficult to remove from the modified wood product and/or take a long time to diffuse out of the modified wood product. Hence allowing the urea to be more readily and effectively removed from the wood product (e.g. in the form of ammonia via reaction with the introduced water) may improve the usability of the modified wood product and/or improve the efficiency of providing a modified wood product with low urea levels. This urea may be more effectively removed by the introduction of water into the reactor during curing because, as mentioned above, urea may react with the water (e.g. relatively efficiently at the temperatures and pressures of the reactor) to produce ammonia gas, thereby reducing or removing the urea from the modified wood product. Although ammonia gas also has an unpleasant smell, ammonia gas may diffuse more readily from the modified wood product as compared to urea and/or may be more efficiently removed from the modified wood product by venting (as described in more detail below). The usability of the modified wood product and/or the efficiency of producing providing an modified wood product with low urea levels may therefore be improved.

The method may comprise, during the heating the resin impregnated wood product in the reactor, introducing inert gas into the reactor. In this context, an inert gas may be taken to include an effectively inert gas. For example, the inert gas may be nitrogen, which although not truly inert will nonetheless substantially not react with the resin impregnated wood product at the temperatures and pressures used in the reactor. Another example is Argon. The inert gas may be introduced into the reactor so as to displace the air (e.g. including oxygen) inside the reactor, which may help prevent reactions of the resin impregnated wood product with the gas (e.g. including oxygen) inside the reactor during curing. The inert gas may be introduced at various stages during heating.

The example method comprises, in step 116, cooling and venting the reactor. For example, after the 1 hour hold time mentioned above, the curing of the resin of the resin impregnated wood product may be complete or substantially fully complete, and hence the modified wood product may be produced. At this point, the heating of the reactor may cease, and the reactor temperature may cool gradually to 60° C. The reactor may be vented to atmospheric pressure. In some examples, the modified wood product may be removed from the reactor at this stage, thereby to provide the modified wood product.

In some examples, the venting may comprise one or more venting cycles. For example, the method may comprise, after the heating the resin impregnated wood product in the reactor so as to substantially cure the resin, venting the reactor to atmospheric pressure, increasing the pressure in the reactor, and then venting the reactor again. For example, the pressure in the reactor may be increased to between 500 kPa and 800 kPa, for example 700 kPa, before the venting to atmospheric pressure again. The venting cycle of increasing the pressure in the reactor and then venting again may be repeated a plurality of times. For example, this may be repeated at intervals, for example intervals having a duration in the range of 4 minutes to 15 minutes, for example 10 minutes, for a period of one hour. Applying the venting cycle may allow the by-products generated during the curing, for example urea and/or and ammonia as mentioned above, to be flushed from modified wood product. As mentioned above, the introduction of water into the reactor during curing may cause the urea by-product to react with the water to produce gaseous ammonia, which may be more efficiently flushed from the modified wood product as compared to urea, and hence may provide that a less intensive venting cycle be used. This may improve the efficiency of the wood modification process. After the venting cycles have completed, the pressure in the reactor is atmospheric, and the reactor temperature has reduced to 60° C., the modified wood product may be removed from the reactor. The resulting modified wood product may then be stored, further cooled, and/or used as appropriate.

The method may comprise applying quality control checks to the modified wood product. For example, samples may be taken from the batch. The number of samples may be determined according to the number of timbers in the batch. The sampling procedure may be according to the standard EN 315-2 (ISO 2859-1) at inspection level S3, with an acceptable quality level (AQL) of 10%. For example, for a batch size of 5 to 150, 5 samples are taken, and the maximum allowed to fail is 1; for a batch size of 151 to 500, 8 samples are taken, and the maximum allowed to fail is 2; for a batch size of 501 to 3200, 13 samples are taken, and the maximum allowed to fail is 3; for a batch size of 35001 to 500000, 32 samples are taken, and the maximum allowed to fail is 7; for a batch size over 500000, 50 samples are taken, and the maximum allowed to fail is 7; and for a batch size of less than five, all pieces are subjected to sampling, and the maximum allowed to fail is 1.

For example, the samples may be obtained as follows. Cross section measuring 300 mm in length may be removed from timbers at least 300 mm from the grain end. Faces of the removed cross section are planed from opposing faces to a sample thickness of 20 mm A strip of wood 20 mm wide is then removed from the centre of the planed cross section with the long axis of the strip running in the direction of the grain, and with edges 10 mm either side of the midline of the planed cross section. A series of 10 samples are then removed from the resulting 20×20×300 mm strip by cross cutting on a fine bandsaw at 5 mm intervals to produce a series of quality control (QC) blocks measuring 20×20×5 mm each. Oven dry weights of each QC block are determined, for example as described above. The dimensions of each QC block are measured and used to determine increases in oven dry wood density. The oven dry wood density may then be used to determine the resin uptake (also termed Weight Percent Gain (WPG)). Limits may be set on the minimum increase in density for pieces so as to pass quality control. The QC blocks may be leached in 100 ml of deionised water for defined periods and the leachate tested for species associated with uncured resin. For example, in the example that phenol formaldehyde resin is used, the leachate may be tested for phenolics associated with uncured resin. Limits may be set on the levels permissible in the leachate passing quality control. The pH of the leachate may also be measured and compared against the pH of leachate from samples known to have cured. The dimensions of the QC blocks may be measured following the leaching when wet and following re-drying (i.e. when they are dry again), and a shrinkage coefficient calculated. Limits may be placed on the shrinkage coefficient for passing quality control. For example, the shrinkage coefficient C_{S} may be calculated as C_{S} (%)=(D_{W}−D_{OD})/(D_{OD}×100) (3), where D_{W} is the dimension of the sample when wet, and D_{OD} is the dimension of the sample when oven dry. The maximum number of samples taken that are permitted to fall outside the threshold for weight percentage gain and shrinkage coefficient are as described above.

The modified wood product has a number of different properties to the source wood used. That is, the wood modification process described above may change a number of the properties of the source wood used in the process.

As one example, the modification process may increase the density of the source wood by in the range of 30 to 80% and more normally in the range 40 to 60%. It will be appreciated that the density increase relates to uptake of resin which may vary between timbers and so this may be an average density increase amongst timbers, for example in a batch. It will also be appreciated that different source wood types may have different resin uptakes and hence the density increase may vary per wood type. For example, the modification process may increase the density of the source wood by 60% for pine sapwood. For example, for pine sapwood, the source wood density may be 440-460 kgm⁻³, and the density of the modified pine wood product may be 550-790 kgm⁻³. As another example, for beech, the source wood density may be around 760 kgm⁻³ and the density of the modified beech wood product may be 870-950 kgm⁻³. In some examples the modified wood product may comprise source wood (for example a timber of source wood as described above) impregnated with cured phenol formaldehyde resin (for example phenol urea formaldehyde resin as described above), and the modified wood product may have a density in the range of substantially 550 kg/m³ to substantially 950 kg/m³. The density of the modified wood product may be substantially independent of the source wood used. For example, a source wood of a relatively high density may take up less resin as a result of the wood modification process than a source wood that is of relatively low density, such that the density of the resulting modified wood products is substantially the same or similar. The increased density of the modified wood product may provide for reduced wear of the modified wood product, and hence may improve utility of the wood product for wear resistant application such as decking and cladding. Further, as described in more detail below, the increased density may allow for the reaction to fire of the modified wood product to be improved as compared to the source wood.

As another example, the reaction to fire of the modified wood product may be improved as compared to the source wood. For example, where the resin used is phenol formaldehyde resin, the modified wood product may have a reaction to fire Euroclass classification of b-s 1, d0 (i.e. as per BSEN 13501-1:2007+A1:2009 Fire classification of construction products and building elements—Part 1: Classification using data from reaction to fire tests). For comparison, most wood products have a classification of D. For example, where the modified wood product comprises source wood (for example source wood as described above) impregnated with cured phenol formaldehyde resin (for example as described above) and having a density of 569.9 kg/m3, the modified wood product has a reaction to fire Euroclass classification of b-s 1, d0.

The reason for the improved reaction to fire is believed to be as follows. Impregnating the source wood with resin fills voids within the wood, and hence reduce the oxygen content within the wood, and hence reduce the propensity of the wood to burn when heat is applied. For example, the modified wood product impregnated with cured resin so that the density of the modified wood product is in the range of substantially 550 kg/m3 to substantially 950 kg/m3 may substantially fill the voids in the wood and hence improve the reaction to fire. Moreover, the cured phenol formaldehyde resin has heat resistant properties. For example, cured phenol formaldehyde resin has a high heat resistance, specifically a decomposition point of 220° C. and a glass transition temperature of 170° C. Therefore, the density of the modified wood product coupled with the heat resistant properties of the phenol formaldehyde resin used may allow for the improved reaction to fire, specifically a reaction to fire Euroclass classification of b-s 1, d0.

The improved reaction to fire of the modified wood product may allow for the modified wood product to be used without requiring treatment using flame retardants. This may reduce costs associated with use of the modified wood product in applications such as building, for example where Building Regulations require materials with greater reaction to fire performance.

As another example, the modified wood product may have an increased hardness as compared to the source wood. For example, for a source wood of radiata pine, the wood modification process, for example using phenol formaldehyde resin, may increase the hardness from 2.67 kN to between 3.62 kN to 5.18 kN, with an average of 4.49 kN. In other words, for a source wood of radiata pine, the modified wood product may have a hardness of between 3.62 to 5.18 kN, with an average of 4.49 kN. This hardness may be as determined using the Janka test over 10 samples (e.g. the average provided above is the average as obtained using the Janka test over 10 samples of the modified wood product).

As another example, the modified wood product may have an increased durability against fungi as compared to the source wood. For example, the modified wood product may have a Durability Class 1—very durable, as per BS EN 350:2016. It is understood that the increased durability against fungi is due at least in part to the reduction of access of water to the cell walls of the wood, which water is necessary for fungal decay. The modified wood product having an increased durability against fungi may allow for an increase the utility of the modified wood product for example in applications such as exterior joinery, cladding and/or decking.

As another example, the modified wood product may have an increased dimensional stability (lower movement) as compared to the source wood. For example, the modified wood product may exhibit only a small movement under stress as compared to the source wood. For example, the dimensional stability may be measured using a movement test where wood is exposed to 90% Relative Humidity and 25° C., then 60% Relative Humidity and 25° C. with the change in dimensions in radial and tangential dimensions assessed. The modified wood product may be in a small movement category where the combined radial and tangential shrinkage are less than 3%. The modified wood product having an increased dimensional stability may allow for an increase in the utility of the modified wood product in applications such as exterior joinery, for example for use in window and/or door frames.

As another example, the modified wood product may have a different colour to the source wood. For example, the modified wood product may be darkened as compared to the source wood, and/or there may be an increased contrast between the earlywood and the latewood, making the wood more attractive. This may improve the utility of the modified wood product in applications such as flooring, furniture and/or cladding, or other interior or exterior applications where appearance is important.

Referring now to FIG. 2, there is illustrated schematically a wood modification system 200 according to an example.

The wood modification system 200 comprises a reactor 202.

The reactor 202 is for producing a modified wood product and is arranged to heat a resin impregnated wood product 206 received therein so as to substantially cure the resin, thereby to produce the modified wood product in use. The resin impregnated wood product 206 may be the same as the resin impregnated wood product described above with reference to FIG. 1. For example, the resin impregnated wood product 206 may be the resin impregnated wood product resulting from step 110 of the method described above with reference to FIG. 1. For example, the resin impregnated wood product may comprise resin impregnated timbers 206, which may be introduced into an internal volume 204 of the reactor 202 ‘on stick’ (see e.g. stickers 208 of FIG. 2) as a batch as described above. The reactor 202 may be the same as and/or used as the reactor described above with reference to the method of FIG. 1. For example, the reactor 202 may be the same as and/or used as the reactor of steps 112 to 116 of the method described above with respect to FIG. 1. The heating the resin impregnated wood product 206 so as to substantially cure the resin may be the same or similar to as described in steps 112 to 116 described above with reference to FIG. 1.

The reactor 202 comprises a sealable door portion 210 to allow resin impregnated wood product 206 to be introduced therein (i.e. into the internal volume 204 thereof), and the modified wood product to be removed therefrom. The sealable door portion 210 is sealable to withstand the pressure increase and/or decrease in the reactor 202, for example the pressures described in steps 112 to 116 of the method described above with reference to FIG. 1.

The reactor 202 comprises temperature sensors 218, 224 to sense the temperature inside the reactor. The reactor 202 may also comprise temperature sensors (not shown) as described above arranged to measure a core temperature of one or more of the resin impregnated wood timbers 206 received therein. The reactor comprises pressure sensors 220, 222, arranged to measure the pressure inside the reactor 202. The temperature sensors 218 224 and/or the pressure sensors 220, 222 may be spatially distributed inside the reactor so as to obtain measurements spanning the dimensions of the reactor thereby to allow more accurate measurements of temperature and pressure to be made.

The reactor comprises a heating means 212 for heating the resin impregnated wood product 216. The heating means 212 may be arranged to cause heating of the resin impregnated wood product 206 inside the reactor 202, for example as described in any one of steps 112 to 116 of the method described above with reference to FIG. 1. In this example, the heating means 212 comprises a heating jacket 212 arranged around the outside of the reactor 202. The heating jacket 212 is in fluid communication with a heating element 240, a heating circulation pump 242, and an expansion tank. When heating of the reactor 202 is required, the heating element 240 may be controlled to heat fluid, for example oil, for example to a defined temperature. The heated fluid may then be pumped to the heating jacket 212 by the heat circulation pump 242 so as to heat the reactor 202. When cooling of the reactor 202 is required, the heating element 240 may be controlled to reduce or cease heating of the fluid. Alternatively, or additionally, the expansion tank 244 may be used to help facilitate cooling of the fluid when required. The use of the heating jacket 212 may allow even and precisely controllable heating of the reactor 212, thereby for reliable curing of the resin impregnated wood product 206.

The system 200 comprises a pressure adjusting means 235 for adjusting the pressure inside the reactor 202. For example, the pressure adjusting means 235 may controllable to increase the pressure inside the reactor 202 and/or draw a reduced pressure inside the reactor 202, for example as described in any one of steps 112 to 116 of the method described above with reference to FIG. 1. In this example, the pressure adjusting means 235 comprises an air receiver 234 and an air compressor/vacuum arrangement 236 (hereinafter referred to as air compressor 236) in fluidic communication with the reactor 202. The air compressor 236 may be controllable to increase the pressure inside the reactor, and the air compressor 236 and/or the air receiver 234 may be controllable to draw a reduced pressure inside the reactor.

The system 202 comprises an inert gas introduction means 232. The inert gas introduction means 232 may be in fluidic communication with the reactor 202, and controllable to introduce inert gas (including e.g. effectively inert gases as described above, for example nitrogen) into the reactor 202. This may allow for the displacement of air inside the reactor 202, for example during heating, and thereby help prevent reactions of the resin impregnated wood product with the gas inside the reactor during curing.

The reactor 202 comprises a venting means 230 to allow air and/or other gases to be vented from inside the reactor 202. For example, the venting means 230 may be arranged to provide for the venting of step 116 of the method described above with reference to FIG. 1. The venting means 230 may comprise one or more safety valves to ensure that the pressure inside the reactor does not exceed a given maximum.

The reactor 202 comprises water introduction means 219 for introducing water into the reactor 202 during heating of the resin impregnated wood product in use. For example, the water introduction 219 means may be arranged to introduce water into the reactor 202 in the same way as described in step 114 of the method described above with reference to FIG. 1. For example, the water introduction means 219 may be arranged to introduce water into the reactor 202 in the form of a spray or aerosol of water. For example, the water introduction means 219 may comprise one or more nozzles 216 (two are shown in FIG. 2) inside the reactor 202, for example arranged to cause water exiting therefrom to be in the form of a fine mist or spray or aerosol. The nozzles 216 may be located at or towards a top portion 215 of the reactor 202 (opposite to a base portion 217 of the reactor by which the reactor 202 is supported and which is closer to the ground than is the top portion 215). The water introduction means 219 may comprise a spray bar arrangement 221 to which the nozzles 216 are connected and which extends outside of the reactor 202 for fluidic connection to a controllable pump or valve arrangement 226 (hereinafter pump arrangement 226). The pump arrangement 226 is fluidically connected to a water source 228. The pump arrangement 226 may be controllable to deliver a defined quantity of water, for example at a defined rate, through the nozzles 216 into the reactor 202, for example in the same way as described for step 114 of the method described above with reference to FIG. 1. The pump arrangement 226 may be arranged to be able to deliver the water at suitably elevated pressures as compared to the pressure inside the reactor during heating, so as to enable the water to be introduced into the reactor 200, for example at sufficient pressures to enable production of a mist or spray or aerosol of water at the nozzles 216.

The water introduction means 219 allows for the introduction of water into the reactor 202 during heating (for curing) of the resin impregnated wood product. As described above, this may allow for several advantages including reduction of cracking of the surface of the resin impregnated wood product 206 during curing; improved reliability and consistency of the curing of the resin impregnated wood product 206; allowing improved removal of curing by-products from the resin impregnated wood product 206; and/or reduction of charring of the surface of the resin impregnated wood product 206 during curing. The reactor 202 therefore allows for the production of an improved modified wood product and/or an improved method of producing the modified wood product.

The system 202 may also comprise a steam trap (not shown) arranged to collect excess steam from the reactor 202, an extractor fan (not shown) arranged to capture and remove vapours from within the reactor 202 at the end of the wood modification process, and/or one or more filters arranged to capture material and debris for example from flowing into and/or out of the reactor 202 to protect components of the system 202.

The above examples are to be understood as illustrative examples of the invention. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

What is claimed is:

1. A method of producing a modified wood product, the method comprising:
heating a resin impregnated wood product in a reactor, the resin impregnated wood product comprising source wood impregnated with a resin composition comprising resin, the heating being so as to substantially cure the resin, thereby to produce the modified wood product;
wherein the method comprises, during the heating of the resin impregnated wood product in the reactor, introducing water into the reactor in the form of a spray or aerosol or mist to add moisture to the surfaces of the resin impregnated wood product, wherein the introducing the water into the reactor comprises introducing the water into the reactor when a core portion of the resin impregnated wood product reaches a temperature in the range 120° C. to 130° C.

2. The method according to claim 1, wherein the introducing the water into the reactor comprises introducing the water into the reactor via one or more nozzles located at or towards a top portion of the reactor.

3. The method according to claim 1, wherein the introducing the water into the reactor comprises introducing a volume of water in the range 20 to 30 millilitres per square meter of surface area of resin impregnated wood product in the reactor.

4. The method according to claim 1, wherein the introducing the water into the reactor comprises introducing water into the reactor at a rate in the range of 700 to 900 millilitres per minute, or preferably at a rate of about 800 millilitres per minute.

5. The method according to claim 1, wherein the resin composition is an aqueous solution of phenol formaldehyde resin.

6. The method according to claim 5, wherein the aqueous solution of phenol formaldehyde resin has a solids content in the range of 20% to 40%, or preferably a solids content of around 30%.

7. The method according to claim 1, wherein the heating the resin impregnated wood product in the reactor so as to cure the resin comprises heating the resin impregnated wood product so that a core portion of the resin impregnated wood product has a temperature in the range 130° C. to 170° C., or preferably a temperature of about 150° C.

8. The method according to claim 1, wherein the heating the resin impregnated wood product in the reactor so as to cure the resin comprises:
sealing the resin impregnated wood product in the reactor;
increasing the pressure in the reactor to a pressure in the range of between about 700 kPa to about 1300 kPa.

9. The method according to claim 1, wherein the method comprises, during the heating the resin impregnated wood product in the reactor, introducing inert gas into the reactor.

10. The method according to claim 1, wherein the method comprises, after the heating the resin impregnated wood product in the reactor so as to cure the resin:
venting the reactor;
increasing the pressure in the reactor; and
venting the reactor again.

11. The method according to claim 1, wherein the method comprises:
impregnating the source wood with the resin composition, thereby to produce the resin impregnated wood product.

12. The method according to claim 11, wherein the source wood has a moisture content in the range of about 10% to about 14%.

13. The method according to claim 11, wherein the method comprises:
prior to the impregnating the source wood with the resin composition, drying the source wood so that the source wood has a moisture content of about 10% to about 14%.

14. The method according to claim 11, wherein the impregnating the source wood with the resin composition comprises:
sealing the source wood in a chamber;
drawing a first reduced pressure in the chamber to cause a partial vacuum in the chamber;
introducing the resin composition into the chamber so as to fully immerse the source wood;
applying a first increased pressure to the resin composition whilst fully immersed so as to impregnate the source wood with the resin composition; and
draining the resin composition from the chamber; and
drawing a second reduced pressure in the chamber to cause a partial vacuum in the chamber so as to remove excess resin composition from the resin impregnated source wood, thereby to produce the resin impregnated wood product.

15. The method according to claim 14, wherein the applying the first increased pressure to the resin composition comprises applying a pressure in the range 1000 kPa to 1400 kPa, or preferably a pressure of around 1200 kPa, to the resin composition.

16. The method according to claim 1, wherein the method comprises:
before the heating the resin impregnated wood product, reducing the moisture content of the resin impregnated wood product to a moisture content in the range of about 4% to about 10%.

17. The method according to claim 16, wherein the reducing the moisture content of the resin impregnated wood product comprises heating the resin impregnated wood product in a kiln at a temperature in the range of about 50° C. to about 60° C.

18. A reactor for producing a modified wood product, the reactor being arranged to heat a resin impregnated wood product received therein in use so as to cure the resin, thereby to produce the modified wood product in use, the reactor comprising:
water introduction means for introducing water in the form of a spray or aerosol or mist into the reactor during said heating of the resin impregnated wood product in use to add moisture to the surfaces of the resin impregnated wood product; and
one or more temperature sensors arranged to measure a temperature of a core portion of the resin impregnated wood product in use;
wherein the reactor is arranged to introduce the water when a core portion of the resin impregnated wood product reaches a temperature in the range 120° C. to 130° C.

19. The reactor according to claim 18, wherein the water introduction means comprises one or more nozzles located at or towards a top portion of the reactor.

20. The reactor according to claim 18, wherein the reactor is arranged to perform a method of producing a modified wood product, the method comprising:
heating a resin impregnated wood product in a reactor, the resin impregnated wood product comprising source wood impregnated with a resin composition comprising resin, the heating being so as to substantially cure the resin, thereby to produce the modified wood product;
wherein the method comprises, during the heating of the resin impregnated wood product in the reactor, introducing water into the reactor in the form of a spray or aerosol or mist to add moisture to the surfaces of the resin impregnated wood product, wherein the introducing the water into the reactor comprises introducing the water into the reactor when a core portion of the resin impregnated wood product reaches a temperature in the range 120° C. to 130° C.
